(19) United States
(12) Patent Application Publication
(10) Pub. No.: US 2010/0044549 A1
(43) Pub. Date: Feb. 25, 2010

(54) ALIGNMENT AND ADJUSTMENT OF A LIGHT PATH

(76) Inventors: Clemens Bibo, Munchen (DE); Karlheinz Schreyer, Wolfratshausen (DE); Armin Tapphorn, Munchen (DE); Erich Wonisch, Wolfratshausen (DE)

Correspondence Address: LERNER GREENBERG STEMER LLP, P O BOX 2480, HOLLYWOOD, FL, 33022-2480, US

(21) Appl. No.: 12/375,126

(22) PCT Filed: Jul. 23, 2007
(86) PCT No.: PCT/EP07/57584

§ 371 Date: Jun. 2, 2009

(30) Foreign Application Priority Data
Jul. 26, 2006 (EP) 06117859.6

(51) Int. Cl. G01J 1/20

(52) U.S. Cl. 250/201.1

(57) ABSTRACT

An efficient method and device for aligning or adjusting a collimated light beam of a linear smoke detector having a light transmitter, a light receiver, a deflection unit, and an evaluation unit. The evaluation unit evaluates the intensity of the collimated light beam that is emitted by the light transmitter and is received at the light receiver. The collimated light beam is deflected by the deflection unit based on the evaluation result from the evaluation unit until a predetermined intensity is reached as detected by the light receiver.

The invention relates to a method and a device for aligning or adjusting a collimated light beam of a linear smoke detector comprising a light transmitter, a light receiver and an evaluation unit.

Linear smoke detectors, also smoke detectors referred to as line extinction detectors, are employed in particular in large or narrow structurally restricted spaces, for example in corridors, warehouses and manufacturing areas and in aircraft hangars and are fitted beneath the ceiling on the walls. In the standard implementation the light transmitter and the light receiver are situated opposite one another and no reflector is required. For a long time these were used only in situations when the spaces are so short that the minimum length of the light beam of approximately 10 m would not otherwise be achieved, or if the side situated opposite the transmitter is not stable or it is not possible to install a receiver there. However, because the implementation using the reflector is more cost-effective and considerably simpler to install, the linear smoke detectors with a reflector, a mirror for example, are becoming increasingly widely accepted.

With regard to the installation, commissioning, alignment and adjustment of a linear smoke detector, the optics need to be arranged accurately in order to ensure that a greatest possible intensity of the light emitted by the light transmitter is received by the light receiver. This alignment of the optics onto the reflector, or onto the light receiver, is the most difficult operation during installation and commissioning and is moreover very expensive because it requires the involvement of two people.

One person operates the detector and the other person must position the reflector or the light receiver such that the output signal from the light receiver reaches its maximum. Naturally, the reflector or the light receiver can also first be fitted and then the detector or the light transmitter aligned to the reflector or receiver, which does not however change anything about the intricacy and complexity of the installation. Linear smoke detectors also exist which have a special adjustment set, as disclosed for example in EP 1443479 B1, which is a type of sighting mechanism that is clamped onto the detector and is used for aligning it with the already mounted reflector.

The object of the present invention is seen to consist in proposing a facility which is as simple and efficient as possible for the automatic alignment or adjustment of a linear smoke detector.

This object is achieved according to the invention in each case by the subject matter of the independent claims. Developments of the invention are set down in the subclaims.

A core element of the invention consists in the fact that for aligning or adjusting a collimated light beam of a linear smoke detector, comprising at least a light transmitter, a light receiver and an evaluation unit, the light intensity of the collimated light beam emitted by the light transmitter and received at the light receiver is evaluated by the evaluation unit. Depending on the result of the evaluation, the collimated light beam is deflected by a deflection unit of the linear smoke detector until a previously defined light intensity detected at the light receiver is reached. In this situation, the deflection unit can form either a unit of the light transmitter or a separate unit which follows the light transmitter. It can consist for example of an optical lens system and/or a reflector, such as a mirror for example, a prismatic mirror etc. A point light source, a laser, at least an LED diode, a laser diode or similar can be used as the light transmitter. The light beam emitted by the light transmitter is deflected by displacing or rotating the deflection unit relative to the light transmitter. The light beam is thus deflected by the change in the solid angle. In order to deflect the light beam it is however also possible to change the angle between the effective lens plane and the midpoint beam. The deflection of the collimated light beam can also be achieved as a result of displacing or rotating the light transmitter relative to the optical axis. The rotation or the displacement can take place in any spatial direction. In a further embodiment according to the invention the light transmitter itself is used as a deflection unit. In this embodiment, the light transmitter can be displaced or rotated and no further device is required in order to deflect the light beam. Electromechanical converters, for example, can in general be used to effect the displacement or the rotation. At least one electromechanical converter is used for this purpose. These can be magnetic, piezoelectric and/or similar converters. The mirror or reflector used for deflecting the light beam can be formed by means of micro-optical components, such as micro-apertures, micro-mirrors etc. whose angles of incidence are adjustable. A further embodiment according to the invention could be that the light transmitter has a light source constructed from light points. Such a type of deflection unit functions in such a manner that only certain luminous points of the light source light up and a radial displacement relative to the optical axis of the light beam can thus be achieved. The light receiver can basically be fitted either opposite the light transmitter or close to the light transmitter. In the case of the second variant, a reflector is required in order to deflect the light beam. This is then installed in the area opposite the light transmitter. The evaluation unit checks, or analyzes, on the basis of the intensity values whether the light beam received by the light receiver represents the emitted light or a scattering or undesired reflection of the emitted light. In order to distinguish between emitted light and scattered or undesirably reflected emitted light, polarized light can be used. In this situation, in the beam path of the light beam a fixed non-rotatable polarizing filter is arranged in front of the reflector situated opposite the light transmitter and a rotatable polarizing filter is arranged in front of the light transmitter and/or the light receiver. As a result of the variations in the brightness value, or the intensity, of the light beam when the planes of polarization are rotated it is possible to detect whether the received light beam in question is the desired useful light or whether it is undesired, scattered or reflected light. In principle, any type of mirror can be used as a reflector. In order to now be able to perform an alignment or an adjustment of the linear smoke detector, the deflection of the light beam emitted by the light transmitter can take place in accordance with a systematic search grid, or search pattern, which is defined beforehand. The light beam is deflected in different positions as long as the light receiver is able to detect the light beam at a previously defined intensity. In order to facilitate the alignment, the light beam can be expanded by the deflection unit until the light is detected by the receiver. Thereafter the light beam is collimated again and deflected in the direction of the light receiver, with the result that the collimated light beam is received by the light receiver at the previously defined intensity. The evaluation unit of the linear smoke detector can evaluate the intensity of the light beam received from the light receiver at a previously defined time interval and if necessary deflect the collimated light beam in such a manner that for example a maximum intensity of the light beam is detected at the light receiver.

A major advantage of the method according to the invention or of the device according to the invention consists in the fact that the alignment effort for smoke detectors of such a type can be considerably reduced.

A further advantage is the fact that a misalignment is automatically corrected. Misalignments of the linear smoke detector occur for example in the case of a thermal expansion of the wall on which the linear smoke detector is fitted, for example in an assembly area. Only by this means does an installation of light paths in buildings having a steel construction become possible.

Basically, variations and deviations can be ascertained and corrected accordingly. Such types of variations can additionally be used, for example, in order to recognize dangers associated with the structural system of a building. When using the method according to the invention, it is possible to measure the roof load, the stresses on the building construction, and to provide a department responsible for this with early information in the event of a deviation from a particular value.

The invention will be described in detail with reference to an exemplary embodiment illustrated in a figure. In the drawings:

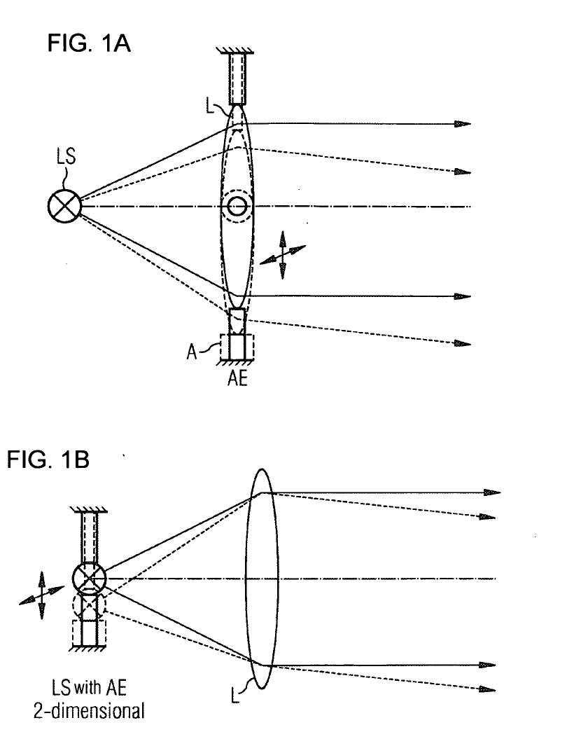

FIG. 1 shows two embodiments according to the invention with an electromechanical converter for executing the method,

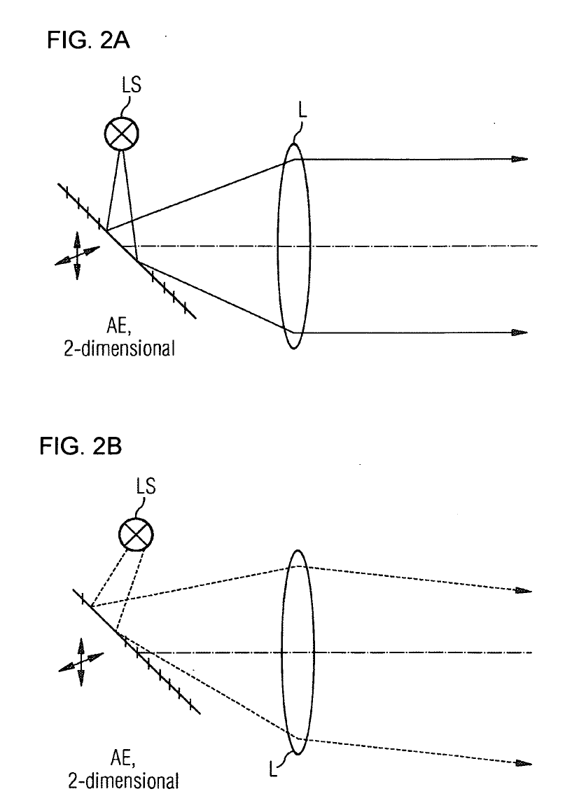

FIG. 2 shows a further embodiment according to the invention with micro-mirrors as micro-optical components for executing the method,

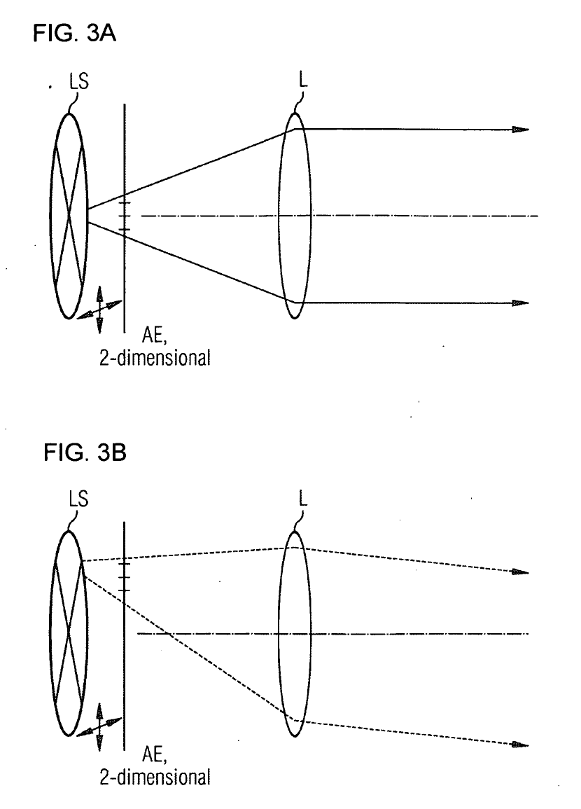

FIG. 3 shows a further embodiment according to the invention with apertures as micro-optical components for executing the method,

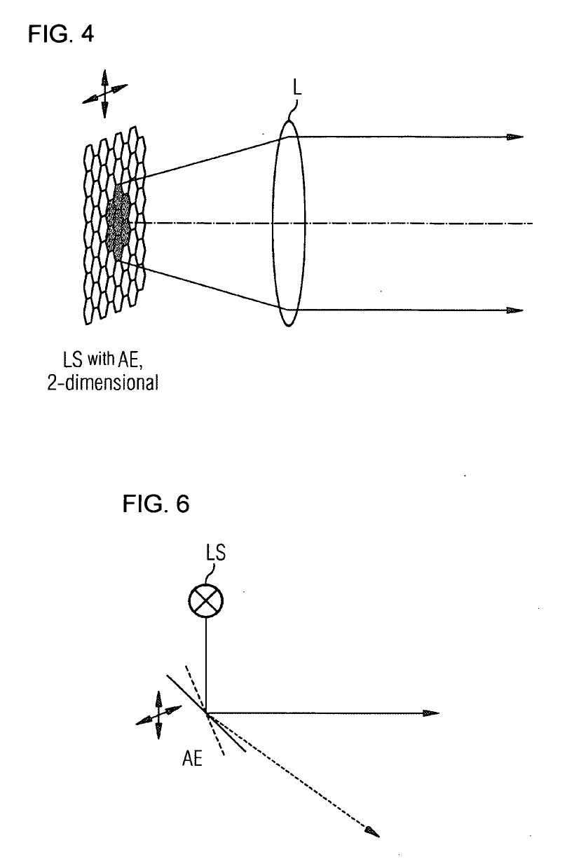

FIG. 4 shows a further embodiment according to the invention with light-point light transmitters for executing the method,

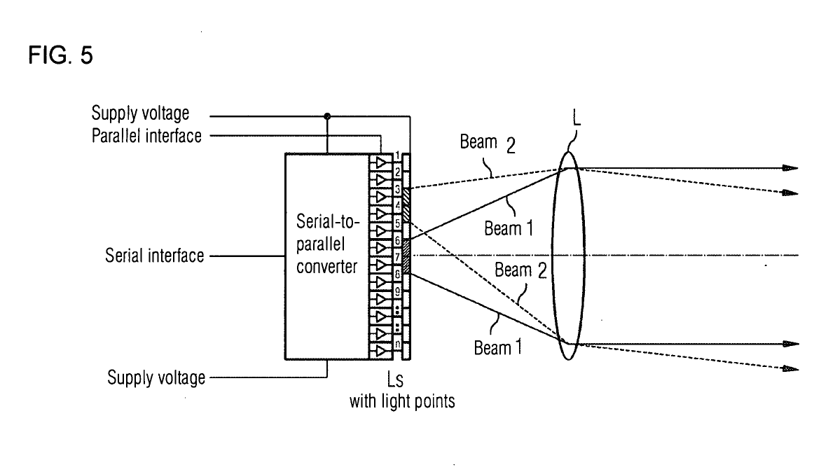

FIG. 5 shows the change in the light beam produced by the device according to the invention with a light-point light transmitter,

FIG. 6 shows a further embodiment according to the invention with a mirror for executing the method,

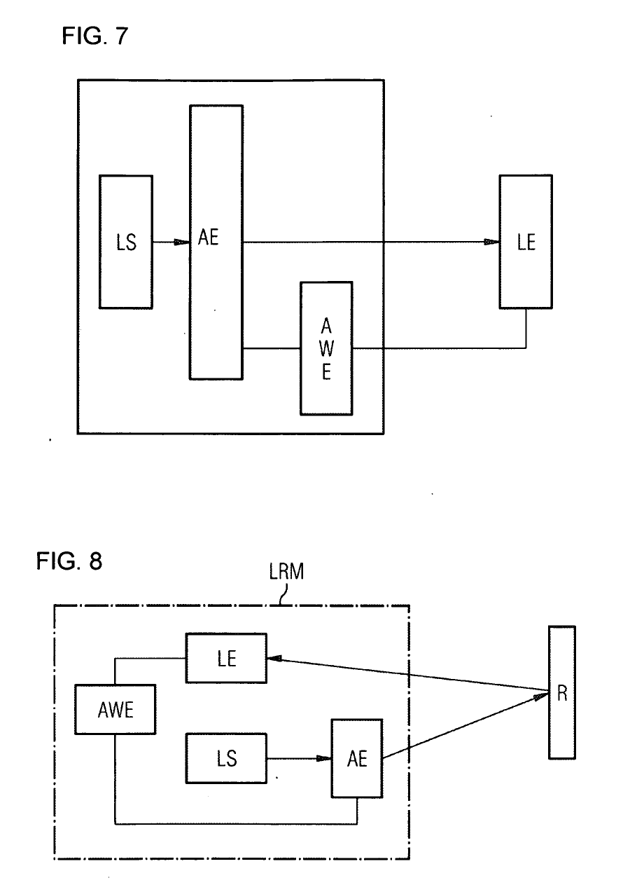

FIG. 7 shows a first variant of a linear smoke detector according to the invention,

FIG. 8 shows a second variant of a linear smoke detector according to the invention.

FIG. 1 shows two embodiments according to the invention which use electromechanical converters A, so-called actuators. In accordance with Figure a), the collimated light beam emitted by the light transmitter LS is deflected by the deflection unit, comprising an optical lens system L, whereby the lens system L is displaced by means of electromechanical converters. A point light source is preferably used as the collimated light beam. A change in the solid angle of the light beam is achieved through the deflection of the light beam. This happens due to the fact that the deflection unit AE with the optical lens system L and the actuators A is displaced relative to the light transmitter LS. A further possibility consists in the fact that the change in the emitted solid angle is achieved as a result of the fact that the inclination of the deflection unit AE is tilted by a particular angle. Magnetic, piezoelectric or similar converters can be used as electromechanical converters. As a general rule, the motion of the actuators is normal to the optical axis. In principle it is also conceivable that the angle between the effective lens plane and the midpoint beam is changed in order to deflect the light beam. In Figure b) the deflection unit AE is connected to the light transmitter LS. In this embodiment, the deflection unit AE consists of electromechanical converters A with which the light transmitter LS can be displaced or rotated in the object plane.

FIG. 2 shows a further embodiment according to the invention. In this embodiment, the deflection unit AE consists of a mirror with micro-optical components, whose angle of incidence is adjustable. Micro-mirror areas are used as the micro-optical components in this embodiment.

FIG. 3 shows a further embodiment according to the invention. In this embodiment, the deflection unit AE consists of an aperture with micro-optical components.

FIG. 4 and FIG. 5 show the change in the light beam produced by the device according to the invention with a light-point light transmitter LS. The light transmitter LS is a light source made up of a large number of light points. The emitted light beam is displaced as a result of only the light points required for the displacement lighting up, or being activated. Such a light transmitter LS can, for example, be an LED light source consisting of a two-dimensional LED area. The exit angle, exit cone and shape of the light beam can come about as a result of energizing the light points required in order to deflect the light beam.

FIG. 6 shows a further embodiment according to the invention with a mirror for executing the method. In order to deflect the light beam emitted by the light transmitter LS a mirror is used which can be tilted in two orthogonal axes. A further embodiment could be that a combination of two mirrors is used which can each be tilted in one of the orthogonal axes. Electromechanical converters A can be used for tilting the mirrors, or the mirror.

FIG. 7 shows a first variant of a linear smoke detector LRM according to the invention. The linear smoke detector LRM, fitted in a structurally restricted space, has a light transmitter LS, a deflection unit AE, a light receiver LE fitted opposite the light transmitter and an evaluation unit AWE. A collimated light beam emitted by the light transmitter LS is deflected by a deflection unit AE in such a manner that the light beam is received at the light receiver. The received intensity of the light beam is evaluated by the evaluation unit AWE. Depending on the result of the evaluation, the light beam is deflected by the deflection unit until a previously defined intensity of the light beam is received at the light receiver LE. In order to simplify the alignment, a search grid can be used for locating the light receiver LE. To this end, the solid angles of the light beam are changed by the deflection unit AE until such time as light is received at the light receiver. A further possibility for simplified alignment consists in the fact that the light beam is expanded until such time as the light receiver LE receives light. Thereafter the light beam is deflected by the deflection unit AE in the direction of the light receiver LE and collimated again. At previously defined time intervals the intensity of the light beam received at the light receiver LE can be evaluated and, depending on the result of this evaluation, the light beam can then be adjusted such that a particular intensity of the light beam is received at the light receiver LE.

FIG. 8 shows a second variant of a linear smoke detector LRM. In this variant, the light receiver LE is arranged close to the light transmitter LS. Ideally, light receiver LE, light transmitter LS, evaluation unit AWE and deflection unit AE are accommodated in one housing. The deflection unit AE can however also constitute a separate unit. The light beam emitted by the light transmitter LS is reflected by a reflector, a mirror or similar for example, to the light receiver LE. As a result of scattering effects it may now be the case that although the light receiver LE detects an intensity of the emitted light beam, no alignment of the smoke detector LRM can however be undertaken. The result of the evaluation from the evaluation unit AWE can therefore contain an item of information from which it is apparent whether the received light is the emitted light (useful light) or an undesired reflection or scattering of the light. This is particularly important if the light transmitter LS and the light receiver LE are arranged close to one another and the light beam is reflected by a reflector R on the opposite side of the space. Polarized light can be used in order to distinguish between useful light and scattered or reflected light. To this end, a generally fixed non-rotatable polarizing filter is arranged in front of the reflector R in the beam path of the light beam. The light transmitter LS and the light receiver on the other hand have a polarizing filter whose filter plane can be rotated. Ideally, the filter plane can be rotated through approximately 90°. In order to now decide whether the reflection is the desired light beam, a variable rotatable polarizing filter is slowly rotated and during this process the intensity values of the light received at the light receiver LE are evaluated by the evaluation unit AWE. If strong variations occur in this situation, this is the useful light. The method according to the invention can be applied not only in linear smoke detectors but also for light paths in photoelectric barriers, in equipment for measuring atmospheric opacity or tectonic movement, in optical transmission paths etc.

1-27. (canceled)

28. A method for adjusting a collimated light beam of a linear smoke detector, comprising the steps of:
providing a light transmitter, a light receiver, a deflection unit, and an evaluation unit;
evaluating an intensity of a collimated light beam emitted by the light transmitter and received at the light receiver; and
deflecting, if required, the collimated light beam in any spatial direction based on the result of the evaluation until a predetermined intensity detected at the light receiver is reached.

29. The method according to claim 28, wherein the deflection unit is a unit of the light transmitter.

30. The method according to claim 29, wherein the deflection unit is a mirror.

31. The method according to claim 28, wherein the light transmitter is selected from a group consisting of a laser, a point light source, and at least an LED diode or a laser diode.

32. The method according to claim 28, including the further step of deflecting the collimated light beam by displacing the deflection unit relative to the light transmitter.

33. The method according to claim 32, including the step of deflecting the collimated light beam by changing a solid angle of the light beam.

34. The method according to claim 32, including the step of changing an angle between an effective lens plane and a midpoint beam to deflect light beam.

35. The method according to claim 31, including the step of deflecting the collimated light beam by displacing the light transmitter relative to an optical axis of the light transmitter.

36. The method according to claim 28, including the step of displacing the deflection unit by using at least one electromechanical converter.

37. The method according to as claimed in claim 36, wherein the at least one electromechanical converter is a magnetic or piezoelectric converters.

38. The method according to claim 30, wherein the mirror comprises micro-optical components having an adjustable angle of incidence.

39. The method according to claim 38, wherein the micro-optical components comprise one of micro-mirrors or micro-apertures.

40. The method according to claim 29, the light transmitter comprises a light source constructed from light points.

41. The method according to claim 40, including the step of deflecting the collimated light beam emitted by illuminating only certain luminous points of the light source.

42. The method according to claim 28, wherein the light receiver is disposed in an area opposite the light transmitter.

43. The method according to claim 28, wherein the light transmitter and the light receiver are arranged close to one another and comprising a reflector disposed opposite the light transmitter and the light receiver, such that the light beam emitted by the light transmitter is reflected to the light receiver.

44. The method according to claim 42, wherein the light receiver is disposed in a structurally restricted space opposite the light transmitter.

45. The method according to claim 28, including the step of determining whether the received light beam represents at least one of an emitted light, a scattered emitted light and a reflected emitted light.

46. The method according to claim 42, including the step of using a polarized light to distinguish between desired useful light and undesired, scattered or reflected light.

47. The method according to claim 43, including the steps of arranging a polarizing filter in front of the reflector and arranging a rotatable polarizing filter in front of each light transmitter and light receiver in a beam path of the light beam.

48. The method according to claim 47, including the step of evaluating variations in the brightness value of the emitted light beam when rotating a plane of polarization of the beam.

49. The method according to claim 42, wherein the reflector is one of a mirror or prismatic mirror.

50. The method according to in claim 28, including the step of deflecting the collimated light beam in accordance with a search grid to adjust the light beam until the light receiver receives emitted light.

51. The method according to claim 28, including the step of expanding the collimated light beam to adjust the light beam until the light receiver receives emitted light.

52. The method according to claim 51, including the steps of collimating the light beam and deflecting the light beam in the direction of the light receiver after the light beam is received by the light receiver such that the collimated light beam is received by the light receiver.

53. The method according to claim 28, including the step of evaluating intensity of the light beam received by the light receiver at a predetermined time interval.

54. The method according to claim 28, wherein the deflection unit is a separate unit disposed following the light transmitter in a beam path of the light beam.

55. The method according to claim 29, wherein the deflection unit is an optical lens system.

56. A device for adjusting a collimated light beam of a linear smoke detector, comprising:
a light transmitter for emitting a collimated light beam;
a light receiver for receiving the collimated light beam;
an evaluation unit for evaluating intensity of the collimated light beam received at said light receiver; and
a deflection unit for deflecting the collimated light beam dependent on results of the evaluation until a predetermined intensity is detected at said light receiver.
